(19) United States
(12) Patent Application Publication
(10) Pub. No.: US 2014/0344703 A1
(43) Pub. Date: Nov. 20, 2014

(54) INFORMATION PROCESSING APPARATUS, INFORMATION PROCESSING METHOD, AND PROGRAM

(71) Applicant: Sony Corporation, Tokyo (JP)

(72) Inventors: Kensuke Onuma, Tokyo (JP); Koji Fukui, Tokyo (JP); Yuta Yamaguchi, Tokyo (JP); Toshiyuki Katsumoto, Tokyo (JP)

(73) Assignee: SONY CORPORATION, Tokyo (JP)

(21) Appl. No.: 14/363,221

(22) PCT Filed: Nov. 29, 2012
(86) PCT No.: PCT/JP2012/080868

§ 371 Date: Jun. 5, 2014

(30) Foreign Application Priority Data
Dec. 14, 2011 (JP) 2011-273049

(51) Int. Cl. G06F 17/21; G06F 3/0481; G06F 17/30; G06F 3/0484

(52) U.S. Cl. CPC G06F 17/211; G06F 3/04847; G06F 3/0481; G06F 17/30056
USPC 715/732

(57) ABSTRACT

An apparatus and a method that perform reproduction control with a high degree of freedom on slideshow reproduction are provided. Reproduction control to which first control data in which information on a reproduction start point and a reproduction end point of an image is recorded and second control data in which information on maximum display time of each image is recorded are applied is performed. When automatic slide paging setting as user setting information is ON (valid), image transition processing is performed according to whether the maximum display time for reproducing the second control data has passed, regardless of whether the reproduction end point of the first control data has passed. For example, if image display time reaches the reproduction end point of the first control data, the image is continuously displayed in a state in which the displayed image is paused, and image transition processing is performed as the maximum display time for reproducing the second control data has passed after the pause.

### TECHNICAL FIELD

The present disclosure relates to an information processing apparatus, an information processing method, and a program. In particular, the present disclosure relates to an information processing apparatus and an information processing method that perform reproduction control of an image and a sound in processing for reproducing an image (slide), and a program.

### BACKGROUND ART

As an embodiment of processing for reproducing an image, there is a slideshow in which a plurality of images (slides) are sequentially displayed in a switched manner. In many cases, when images (slides) are reproduced in a slideshow (also referred to as a browsable slideshow), processing for reproducing sound data such as music in a combined manner is performed.

Recently, a Blu-ray Disc (BD) has been widely used as a medium for recording data. The data recorded in the BD is recorded in a BD format regulated in advance, and the reproduction is performed according to the regulated format at the time of the reproduction.

Specifically, the following data is regulated in the BD standards:

(a) Playlist file having playlist for reproduction control that regulates content reproduction order or the like; and

(b) Clip files including clip AV stream file which is content storage file for storing AV stream data to be a reproduction object and a clip information file which has information on the reproduction position of clip AV stream file or the like.

In addition to the above, various types of data such as an index file, and a movie object file are recorded in the BD, and the content reproduction in which the data is used at the time of the reproduction is performed.

Further, BD-J which is a reproduction program in a Java (Registered Trademark) format is used as a reproduction control application conforming to the BD standards.

Even when a slideshow that is the aforementioned continuous reproduction of images (slides) to which the BD-J is applied is performed, the reproduction according to the BD standards is needed to be performed.

In the reproduction processing of the slideshow, display processing is performed on each image (slide) displayed on a display device according to the sequence regulated in advance, for example, automatic paging to a next image as a regulated display time has passed.

When a setting for the automatic paging is performed as described above, the user may not freely perform control, for example, in which display on an image (slide) is stopped and one slide is continued to be displayed without change.

In addition, as related art disclosing slideshow reproduction processing, there is the following patent literature, for example.

PTL 1 (Japanese Unexamined Patent Application Publication No. 2008-159255) discloses a slideshow using data recorded in a Blu-ray Disc (BD). The configuration disclosed in PTL 1 is a configuration in which the presentation time of each slide is embedded in a fixed manner on the disc in advance, and free control such as a setting in which automatic paging is not performed may not be performed.

Further, PTL 2 (Japanese Patent Application No. 2000-100254) discloses a configuration that has control information to reproduce still image information on a disc such as DVD and that can present remaining time to still image switch. The configuration only can display the remaining time to the user, but may not freely control the setting in which the automatic paging is not performed, or the like, similarly to PTL 1.

### CITATION LIST

### Patent Literature

PTL 1: Japanese Unexamined Patent Application Publication No. 2008-159255
PTL 2: Japanese Unexamined Patent Application Publication No. 2000-100254

### SUMMARY OF INVENTION

### Technical Problem

The present disclosure has been made, for example, in view of the problems as described above, and is to provide an information processing apparatus and an information processing method that realize reproduction control with a high degree of freedom in reproduction processing such as a slideshow, and a program.

### Solution to Problem

According to a first embodiment of the present disclosure, provided is an information processing apparatus including:

a data processing unit that performs reproduction control of a slideshow in which images are sequentially switched and displayed,

in which the data processing unit performs reproduction control by applying

first control data in which information on a reproduction start point and a reproduction end point of each image is recorded, and

second control data in which information on maximum display time of each image is recorded, and

performs image transition processing according to whether the maximum display time for reproducing the second control data has passed, regardless of whether the reproduction end point of the first control data has passed.

Further, according to the embodiment of the information processing apparatus of the present disclosure, when automatic slide paging setting as user setting information is ON (valid), the data processing unit performs image transition processing as the maximum display time for reproducing the second control data has passed.

Further, according to an embodiment of the information processing apparatus of the present disclosure, if setting of still mode information for each image included in the first control data is setting of pause mode for continuously displaying the image after the reproduction reproduction end point has been reached, the data processing unit performs image transition processing as the maximum display time for reproducing the second control data has passed.

Further, according to an embodiment of the information processing apparatus of the present disclosure, if image display time reaches the reproduction end point of the first control data, the data processing unit continues to display the image in a state in which the displayed image is paused, and performs image transition processing as the maximum display time for reproducing the second control data has passed after the pause.

Further, according to an embodiment of the information processing apparatus of the present disclosure, if the maximum display time for reproducing the second control data has passed before image display time reaches the reproduction end point of the first control data, the data processing unit performs the image transition processing.

Further, according to an embodiment of the information processing apparatus of the present disclosure, the first control data is control data regulated in a playlist file which is a reproduction control information file corresponding to the slideshow.

Further, according to an embodiment of the information processing apparatus of the present disclosure, the second control data is control data described as XML data.

Further, according to an embodiment of the information processing apparatus of the present disclosure, the data processing unit receives the second control data from a server connected through a network, and performs reproduction control to which reception control data is applied.

Further, according to a second embodiment of the present disclosure, provided is an information processing method including:

performing reproduction control of a slideshow in which images are sequentially switched and displayed, of an information processing apparatus,

in which a data processing unit performs reproduction control by applying

first control data in which information on a reproduction start point and a reproduction end point of each image is recorded, and

second control data in which information on maximum display time of each image is recorded, and

performs image transition processing according to whether the maximum display time for reproducing the second control data has passed, regardless of whether the reproduction end point of the first control data has passed, in the reproduction control processing.

Further, according to a third embodiment of the present disclosure, provided is

a program causing an information processing apparatus to perform reproduction control of a slideshow in which images are sequentially switched and displayed,

in which a data processing unit performs reproduction control by applying

first control data in which information on a reproduction start point and a reproduction end point of each image is recorded, and

second control data in which information on maximum display time of each image is recorded, and

performs image transition processing according to whether the maximum display time for reproducing the second control data has passed, regardless of whether the reproduction end point of the first control data has passed in the reproduction control processing.

In addition, the program of the present disclosure is a program that can be provided, for example, by a storage medium or a communication medium provided in a computer-readable format for an information processing apparatus, a computer, or a system that can execute various types of programs or codes. Processing corresponding to a program on the information processing apparatus, the computer, and the program can be realized by providing such program in a computer-readable format.

Additional objects, features, or advantages of the present disclosure are clearly presented by the more detailed description based on following embodiments and accompanying drawings of the present disclosure. In addition, the system in the present specification is a configuration obtained by logically assembling a plurality of apparatuses, and each configuration apparatus is not necessarily provided in the same housing.

### Advantageous Effects of Invention

According to the configuration of an embodiment of the present disclosure, an apparatus and a method that perform reproduction control with a high degree of freedom on slideshow reproduction can be realized.

Specifically, an apparatus and a method that perform reproduction control with a high degree of freedom on slideshow reproduction are provided. Reproduction control to which first control data in which information on a reproduction start point and a reproduction end point of an image is recorded and second control data in which information on maximum display time of each image is recorded are applied is performed. When automatic slide paging setting as user setting information is ON (valid), image transition processing is performed according to whether the maximum display time for reproducing the second control data has passed, regardless of whether the reproduction end point of the first control data has passed. For example, if image display time reaches the reproduction end point of the first control data, the image is continuously displayed in a state in which the displayed image is paused, and image transition processing is performed according to a lapse of the maximum display time for reproducing the second control data after the pause.

According to such processing, an apparatus and a method that perform reproduction control with a high degree of freedom on slideshow reproduction can be realized.

### BRIEF DESCRIPTION OF DRAWINGS

FIG. 1 is a diagram illustrating an example of a usage configuration to which an information processing apparatus according to the present disclosure is applied.

FIG. 2 is a diagram illustrating a configuration example of the information processing apparatus according to the present disclosure.

FIG. 3 is a diagram illustrating a data storage example conforming to the BD standards.

FIG. 4 is a diagram illustrating a configuration and reproduction processing of content conforming to the BD standards.

FIG. 5 is a diagram illustrating a configuration of a playlist applied to slideshow reproduction.

FIG. 6 is a diagram illustrating an example of processing for reproducing a slideshow to which a playlist is applied.

FIG. 7 is a diagram illustrating an example of processing for reproducing the slideshow to which a playlist is applied.

FIG. 8 is a diagram illustrating information corresponding to a play item which is stored in a playlist file.

FIG. 9 is a diagram illustrating information corresponding to a sub path which is stored in a playlist file.

FIG. 10 is a diagram illustrating an example of processing for reproducing a slideshow according to content with a setting in which Still mode=2.

FIG. 11 is a diagram illustrating an example of processing for reproducing a slideshow to which new control information of the present disclosure is applied.

FIG. 12 is a diagram illustrating an example of reproduction control information applied to the information processing apparatus of the present disclosure.

FIG. 13 is a diagram illustrating an example of a screen (GUI) for a setting of automatic slide paging.

FIG. 14 is a flow chart illustrating a processing sequence for a setting of automatic slide paging.

FIG. 15 is a diagram illustrating two image transition processing modes according to whether child slide paging is set.

FIG. 16 is a flow chart illustrating a slideshow reproduction sequence performed by the information processing apparatus of the present disclosure.

FIG. 17 is a diagram illustrating an example of processing for renewing control data by receiving the data from a server connected through a network.

### DESCRIPTION OF EMBODIMENTS

Hereinafter, an information processing apparatus, an information processing method, and a program thereof will be described in detail with reference to the accompanying drawings. Further, the description will be made according to the following items.

1. With respect to configuration example of content reproduction processing system to which information processing apparatus according to the present disclosure is applied

2. With respect to configuration example of hardware of information processing apparatus

3. With respect to data recording configuration corresponding to BD standards

4. With respect to playlist file to which slideshow reproduction is applied

5. With respect to reproduction processing example for image and sound in slideshow reproduction

6. With respect to specific example of reproduction control information of playlist file which is applied to slideshow reproduction

7. With respect to specific example of reproduction corresponding to setting of still mode

8. With respect to configuration that enables stop and transition of image (slide) to be freely controlled

9. With respect to processing sequence for executing information processing apparatus

10. With respect to renewal processing in which control information from server is used

11. With respect to collective configuration of the present disclosure

[1. With Respect to Configuration Example of Content Reproduction Processing System to which Information Processing Apparatus According to the Present Disclosure is Applied]

First, a configuration example of content reproduction processing system to which the information processing apparatus according to the present disclosure is applied is described.

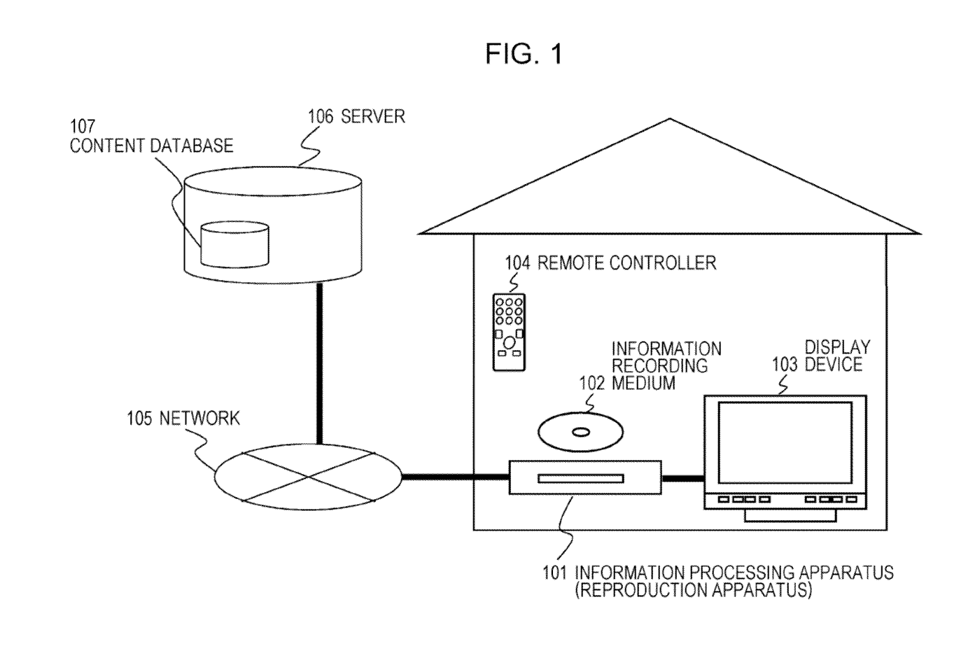

FIG. 1 is a diagram illustrating an example of a content reproduction processing system to which the information processing apparatus according to the present disclosure is applied.

In addition, in the embodiments described below, an embodiment of slideshow reproduction using a Blu-ray Disc (BD) is described as an example of content reproduction processing to which the information processing apparatus is applied. In the slideshow reproduction processing, a plurality of images (slides) are sequentially displayed in a switched manner. Further, when reproducing the images (slides), it is possible to reproduce the images (slides) together with sound data such as music.

As illustrated in FIG. 1, an information storage medium 102 such as Blu-ray Disc (BD) is mounted on an information processing apparatus (reproduction apparatus) 101, and processing of reproducing recorded data of the information storage medium 102 is performed. The image or sound as reproduction data is output to a display device 103 connected through an HDMI cable, a component cable, a composite cable, or the like.

The user uses a remote controller 104, and controls reproduction of videos or Graphic User Interface (GUI) provided by a program. Further, the information processing apparatus 101 can be connected to a network 105, communicate with a server 106 on the network, and obtain information from the network.

In the example of FIG. 1, the server 106 has a content database 107, the information processing apparatus 101 performs communication with the server 106 through the network, and performs, for example, processing for downloading new contents or control information, and processing for renewing control information or recorded content on the information storage medium 102.

### [2. With Respect to Configuration Example of Hardware of Information Processing Apparatus]

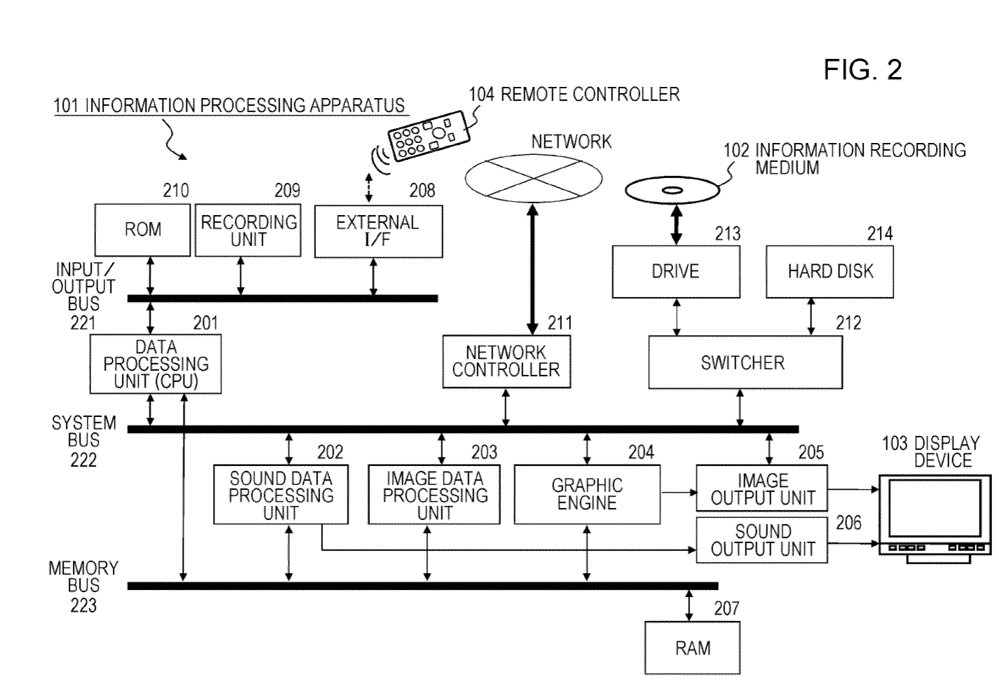

FIG. 2 is a diagram illustrating a hardware configuration example of the information processing apparatus 101.

As illustrated in FIG. 2, the information processing apparatus 101 includes a data processing unit (CPU) 201, a sound data processing unit 202, an image data processing unit 203, a graphic engine 204, an image output unit 205, a sound output unit 206, a RAM 207, an external IF 208, a storage unit 209, a ROM 210, a network controller 211, a switcher 212, a drive 213, and a hard disk 214, which are connected through an input/output bus 221, a system bus 222, and a memory bus 223.

For example, the information storage medium 102 such as a Blu-ray Disc (BD) or the like is mounted on the information processing apparatus 101, processing of reproducing a content (an image, a sound, or the like) input from the information recording medium 102 through the drive 213 is performed.

BD-J that is a reproduction program in a Java (Registered Trademark) format as a reproduction control application corresponding to the BD standards is recorded on the information recording medium 102, and the data processing unit (CPU) 201 executes the reproduction program.

For example, a slideshow (also referred to as a browsable slideshow) in which images (slides) recorded on the information recording medium 102 are sequentially reproduced in a switched manner may be performed. At the time of the reproduction processing, the images (slides) are reproduced together with sound data recorded on the information recording medium 102.

Processing such as decoding processing in the sound data processing unit 202, the image data processing unit 203, or the graphic engine 204 is performed on the image data and the sound data as reproduction data and the processed data is output to the display device 104 through the image output unit 205, and the sound output unit 206.

The data processing unit 201 performs data reproduction control. For example, the data processing unit 201 performs processing according to various commands (instructions) which are input in response to a user operation from the remote controller 103 through the external IF 208. Specifically, processing or the like is performed corresponding to an instruction for switching an image (slide) or an instruction for switching a sound.

In addition, the control program such as data reproduction processing is stored on the information recording medium 102, or the ROM 210, loaded to the RAM 207 at the time of activation, and executed by the data processing unit 201.

Input or output of data for the drive 213 and the hard disk 214 is controlled by the switcher 212. In addition, for example, when communication with the server 106 or the like is performed by using the network, as illustrated in FIG. 1, a connection to the network is performed through the network controller 211.

### [3. With Respect to Data Recording Configuration Corresponding to BD Standards]

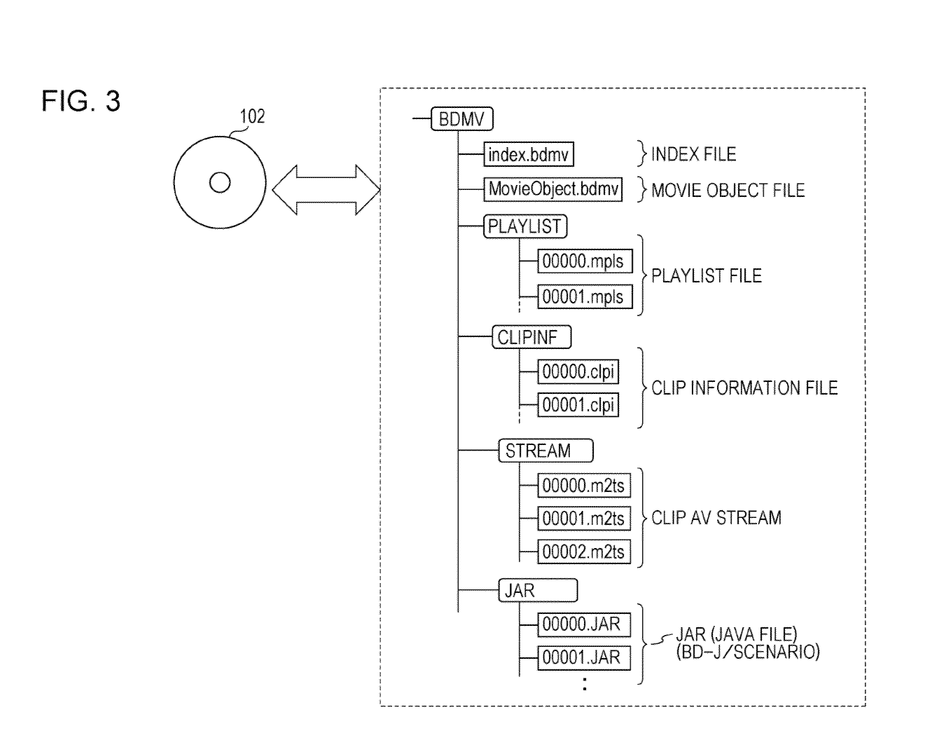

Next, a configuration example of data stored on the information recording medium (BD) 102 is described with reference to FIG. 3.

A directory corresponding to the data recorded on the BD has a configuration illustrated in FIG. 3. In the directory, as illustrated in FIG. 3, for example, files are set as follows:

an index file,

a movie object file,

playlist files,

clip information files,

clip AV stream files, and

JAR files.

Index information which is applied to the reproduction processing, for example, a title is stored in the index file. The user can designate the specific reproduction data based on the index information and perform predetermined content reproduction processing.

The movie object file is a reproduction processing program which is applied to content reproduction processing. For example, a predetermined reproduction processing program is selected by the title included in the index file and the content reproduction control is performed.

The playlist file is a file that is designated according to the title and that regulates a content reproduction order or the like according to the program information of the reproduction program, and has designation information for the clip information having the reproduction position information, or the like.

The clip information file is a file that is designated according to the playlist file, and has the reproduction position information or the like of the clip AV stream file.

The clip AV stream file is a file in which the AV stream data such as image or sound data or the like to be a reproduction object is stored.

The JAR file is a BD-compliant JAVA (Registered Trademark) program (BD-J), is configured with, for example, a reproduction control program which is applied to the slideshow reproduction according to the present disclosure. The predetermined JAR file is selected, for example, by the title which is included in the index file, in the same manner as the movie object file, and the content reproduction control is performed.

The slideshow reproduction processing used for the content recorded on the information recording medium 102 is performed according to the following processing sequence by applying, for example, the BD-compliant JAVA (Registered Trademark) program (BD-J).

First, if the user selects a title for designating the reproduction of the slideshow, BD-J that is a slideshow reproduction program corresponding to the selected title is selected.

A playlist (file) for regulating a content reproduction sequence is selected according to the selected reproduction program (BD-J).

Clip AV stream files for each of the image and the sound as actual content data are read according to the clip information regulated by the selected playlist and the reproduction of the read image and sound is performed.

[4. With Respect to Playlist File to which Slideshow Reproduction is Applied]

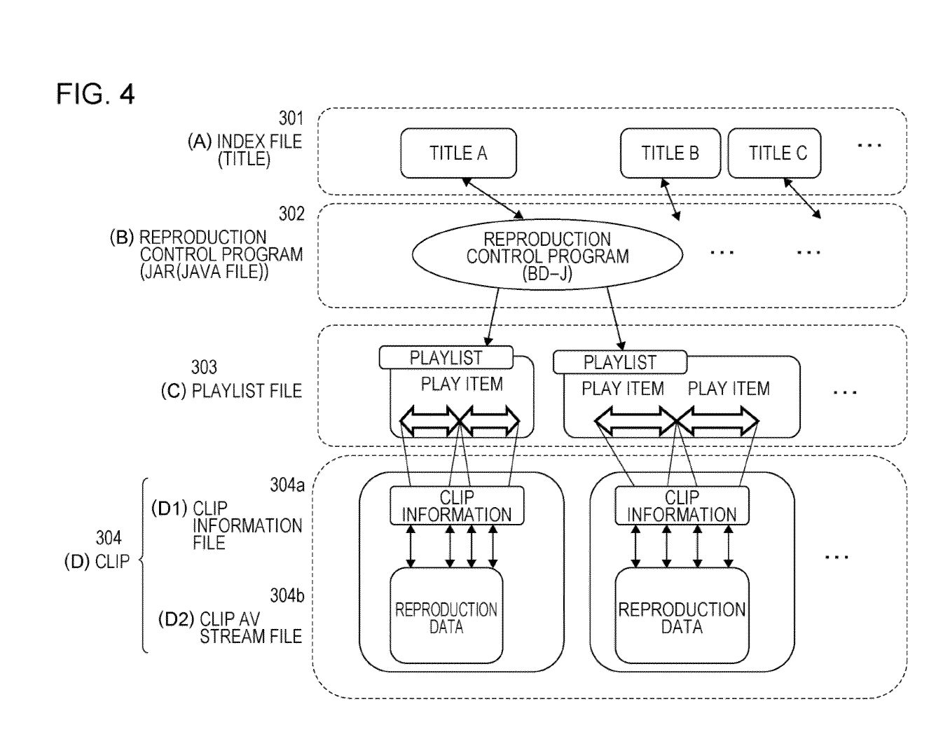

An outline of the slideshow reproduction processing using the reproduction control program (BD-J) and the playlist file is described with reference to FIG. 4.

FIG. 4 is a diagram illustrating reproduction data (clip AV stream file) which is a content file recorded on the information recording medium (BD) 102 and data used for reproduction control of the content. In specific, the data are as follows:

(A) Index file 301,

(B) JAR (JAVA (Registered Trademark)) file 302,

(C) Playlist file 303, and

(D) Clip 304.

(D) The Clip 304 is configured with the data as follows:
(D1) Clip information file 304a, and
(D2) Clip AV stream file 304b.

The image data and the sound data to be reproduction objects is stored in (D2) the clip AV stream file 304b. In addition, the image and the sound are stored in individual files, respectively.

The playlist file 303 is a file in which the reproduction control information is stored, obtains the clip information file 304a (xxxxx.clpi) that is associated with the clip AV stream file 304b (xxxxx.m2ts) of the reproduction target, and the content reproduction control is performed.

The reproduction control program (BD-J) 302 is a BD-compliant JAVA (Registered Trademark) program. The reproduction control program (BD-J) 302 performs the content reproduction control by using the playlist file 303 and the like.

The playlist includes a play item (also referred to as a main play item or a main path) and a sub play item (also referred to as a sub path) which are the information for designating the reproduction object data. The plurality of play items thereof can be set for one playlist.

The reproduction control is performed in the slideshow reproduction according to the main play item and the sub play item included in the playlist for the slideshow reproduction.

Specifically,

the reproduction section of the clip in which the image (slide) content is stored is regulated according to the main play item, and the reproduction control of the image (slide) data is performed according to the main play item.

The reproduction section of the clip in which the sound content is stored is regulated according to the sub play item, and the sound data reproduction control is performed according to the sub play item.

In this manner, the playlist applied to the slideshow reproduction is configured to perform the image (slide) reproduction control by applying the main play item (main path) and to perform the sound reproduction control by applying the sub play item (sub path).

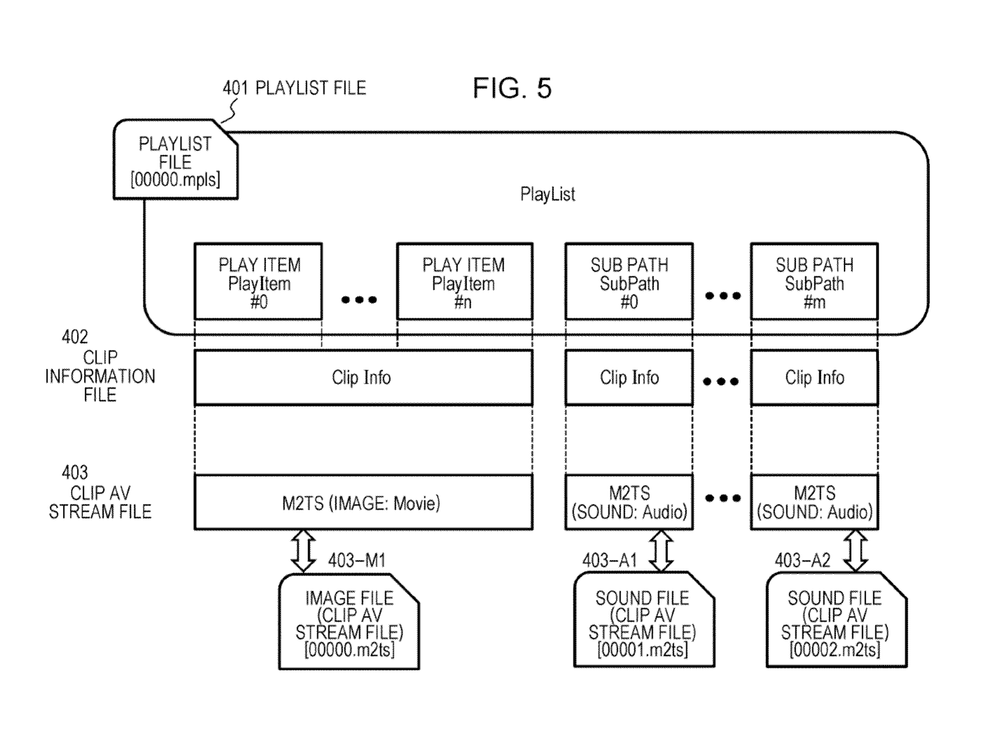

FIG. 5 is a diagram illustrating a slideshow reproduction example to which a playlist is applied.

In the slideshow reproduction, the following data are used:

a playlist file (00000.mpls) 401,

a clip information file 402, and

a clip AV stream file 403.

In the clip AV stream file 403, the following data are used:

an image file (00000.m2ts) 403-M1 in which image data corresponding to a plurality of slides are stored, and

a plurality of sound files (00001.m2ts to 0000n.m2ts) 403-A1, A2, A3, or the like in which individual sound data is stored respectively.

In addition, the JAR file is used for playlist selection processing and other reproduction control.

The image file (00000.m2ts) 402 is a file in which an image (slide) displayed at the time of slideshow reproduction is recorded as image data with a certain length. Time combined to each image display time is recorded in the playlist file (00000.mpls) 401 as a play item.

Reproduction control information of the slideshow reproduction is recorded on the playlist file (00000.mpls) 401.

The detailed control information thereof will be described below.

The playlist file (00000.mpls) 401 is a file selected in association with Title 1 of a reproduced slideshow.

The playlist file (00000.mpls) 401 includes play items and sub paths to which a plurality of numbers are given.

The play item is information that indicates an image reproduction section or the like, and has information on the used clip and information on the section thereof. Generally, the images (slides) are reproduced in a numerical order of the play items.

Further, the sub path has information for designating sound clip information and information on the sound reproduction section.

The clip information files 402 are associated with individual clip AV stream files one by one.

As illustrated in FIG. 5, a play item (=main path) for image control and sub path (=sub play item) for sound control are included in the playlist file (00000.mpls) 401.

In addition, in the following description,

playlist stored data for controlling an image is described as a “play item” and

playlist stored data for controlling a sound is described as a “sub path”.

As illustrated in FIG. 5,

a plurality of play items for controlling an image, that is, Play items #0, #1, #2 to #n are included in the playlist file (00000.mpls) 401.

Play item #0 has reproduction control information of one item of image data [Image 0 (Slide 0)] in the image file (00000.m2ts) 403-M1 in which a plurality of images are stored.

In the same manner, Play item #1 has reproduction control information of [Image 1 (Slide 1)] in the image file (00000.m2ts) 403-M1, and Play item #2 has reproduction control information of [Image 2 (Slide 2)] in the image file (00000.m2ts) 403-M1. In the same manner, each play item has reproduction control information of each image, and the reproduction control of each image is performed by each play item.

In addition, the reproduction control information of each play item will be described below, but the reproduction control information includes, for example, information for indicating a reproduction start position (In Time) and a reproduction end position (Out Time) in the image file (00000.m2ts) 403-M1 corresponding to the image (slide) to be the reproduction object of each play item.

Further, sub paths for controlling a plurality of sounds, that is, Sub path #0, #1, #2, and the like are recorded in the playlist file (00000.mpls) 401, as illustrated in FIG. 5.

Sub path #0 has the reproduction control information of the sound data in the sound file (00001.m2ts) 403-A1.

In the same manner, Sub path #1 has the reproduction control information of the sound file (00002.m2ts) 403-A2. Sub path #2 has the reproduction control information of the sound file (00003.m2ts) 403-A3. Hereinafter, in the same manner, each sub path has the reproduction control information of each sound file, and the reproduction control of each sound is performed according to each sub path.

The control information corresponding to each sub path will be described below, but in the same manner as the control information corresponding to the play item, information on the reproduction start position (In Time) and the reproduction end position (Out Time) of each sound file (xxxxx.m2ts) is included.

### [5. With Respect to Reproduction Processing Example for Image and Sound in Slideshow Reproduction]

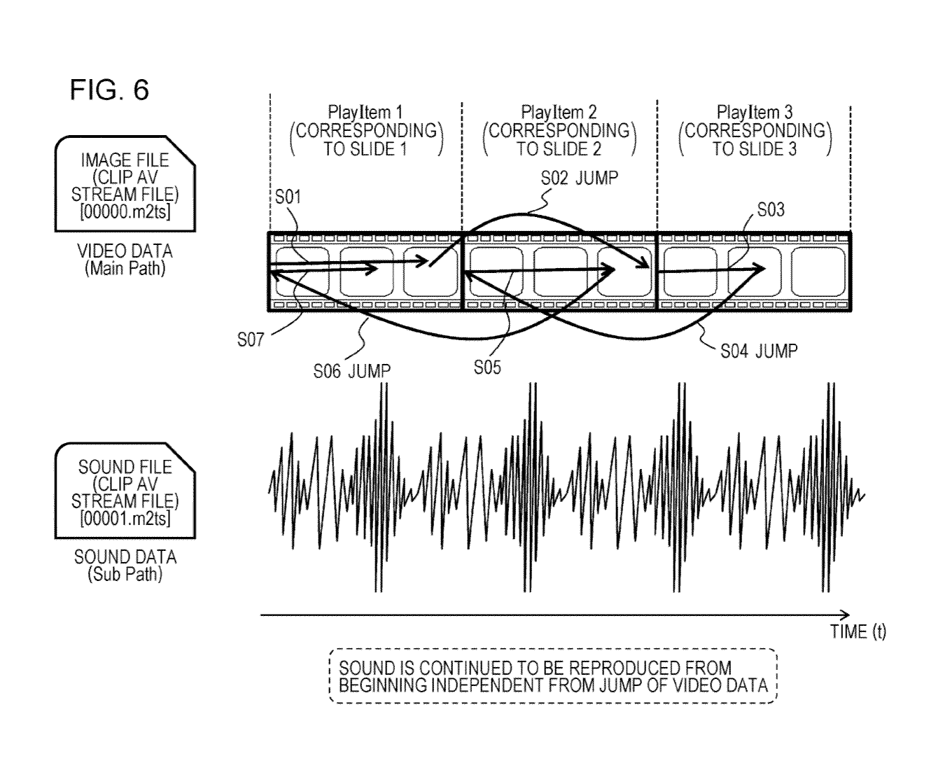

A specific reproduction processing example for an image and a sound in a slideshow is described with reference to FIG. 6.

Specifically, images are sequentially reproduced from the beginning of a play item set in a playlist corresponding to a slideshow.

However, it is possible to jump to another play item set in the playlist corresponding to the slideshow, for example, by an operation of a user, for example, an operation of the remote controller 104 illustrated in FIG. 1.

In the example illustrated in FIG. 6, illustrated is a sequence for transitioning from each play item and reproducing an image (slide) corresponding to each play item in the manner in which the image production by using Play item 1 which is on the beginning of the play item set in the playlist corresponding to the slideshow is started, and each play item transitions from:

Play item 1, to

Play item 3,

Play item 2, and then

Play item 1.

Specifically,

the switching and reproduction of images (slides) is performed in an order of:

Step S01: Reproduction of Slide 1 corresponding to Play item 1,

Step S02: Jump processing [Switching of play item (from Play item 1 to Play item 3)],

Step S03: Reproduction of Slide 3 corresponding to Play item 3,

Step S04: Jump processing [Switching of play item (from Play item 3 to Play item 2)],

Step S05: Reproduction of Slide 2 corresponding to Play item 2,

Step S06: Jump processing [Switching of play item (from Play item 2 to Play item 1)], and

Step S07: Reproduction of Slide 1 corresponding to Play item 1.

In the reproduction of the images (slides), the aforementioned switching is possible, but at this point, the sound data reproduced in the sub path continues to be reproduced by using the sound file designed by one sub path, independently from the transition of the image without being interrupted on the beginning of the sound file.

The image switching can be performed by an input of information on the sending, the sending back, and the designating of a page, for example, which is performed by an operation of the remote controller 104 by the user. In addition, the page is a parameter that corresponds to each image (slide) reproduced according to each play item and that can be designated by the user.

The page switch can be performed according to an operation command, for example, conforming to the BD standards, and free switch and reproduction of pages as described with reference to FIG. 6 can be performed.

However, the image switch can be performed in the BD standards, but a pause function or an operation of changing speed for the reproduction of an image according to the user operation is not provided in the BD standards and reproduction may not be freely controlled in this manner.

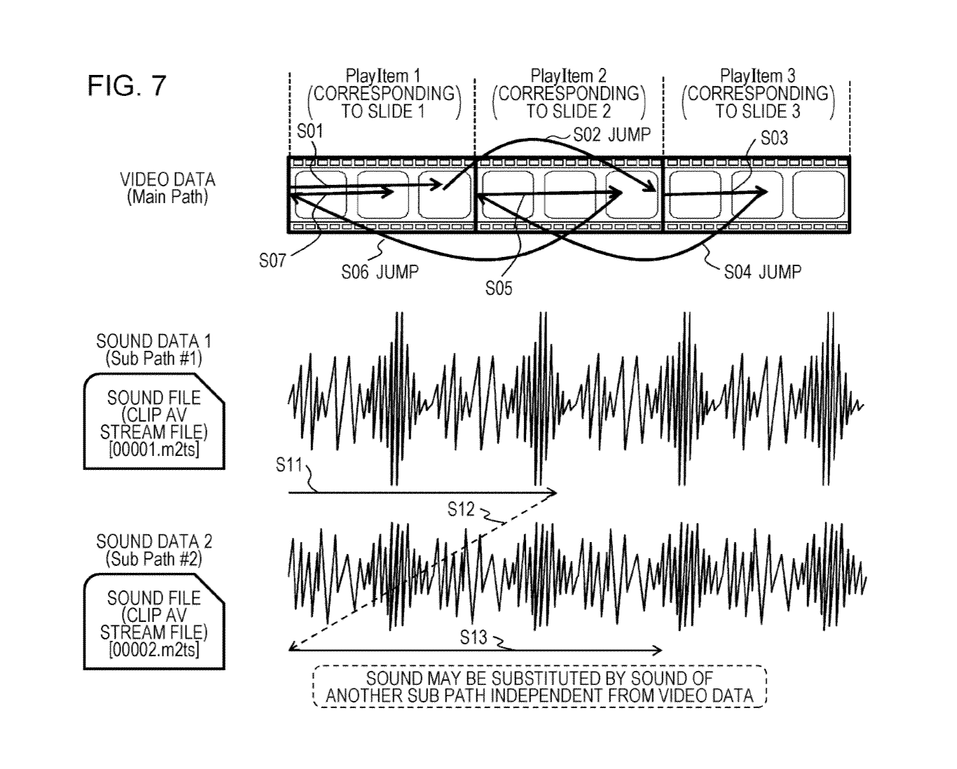

Next, a structure for switching a sound in a slideshow is described with reference to FIG. 7. For example, sound switch of switching Sound data 1 designated in Sub path #1 to Sound data 2 designated in Sub path #2 can be performed based on the user operation.

Specifically, processing of switching a reproduced sound is performed according to operations of Steps S11 to S13 illustrated in FIG. 7. That is, sound switch control can be performed as follows:

S11: Reproduction of Sound data 1 according to Sub path #1,

S12: Sound switch (switch of sub path), and

S13: Reproduction of Sound data 2 according to Sub path #2.

The image controlled according to a play item is not influenced by any sound switching during such sound switching, and controlled according to the play item.

Such sound switching processing is accepted as processing that conforms to the BD standards similar to the image switching processing, but a pause function or an operation of changing speed for the reproduction of a sound according to the user operation is not provided in the BD standards. Therefore, there is a problem in that only the control reproduction with a low degree of freedom can be performed.

[6. With Respect to Specific Example of Reproduction Control Information of Playlist File which is Applied to Slideshow Reproduction]

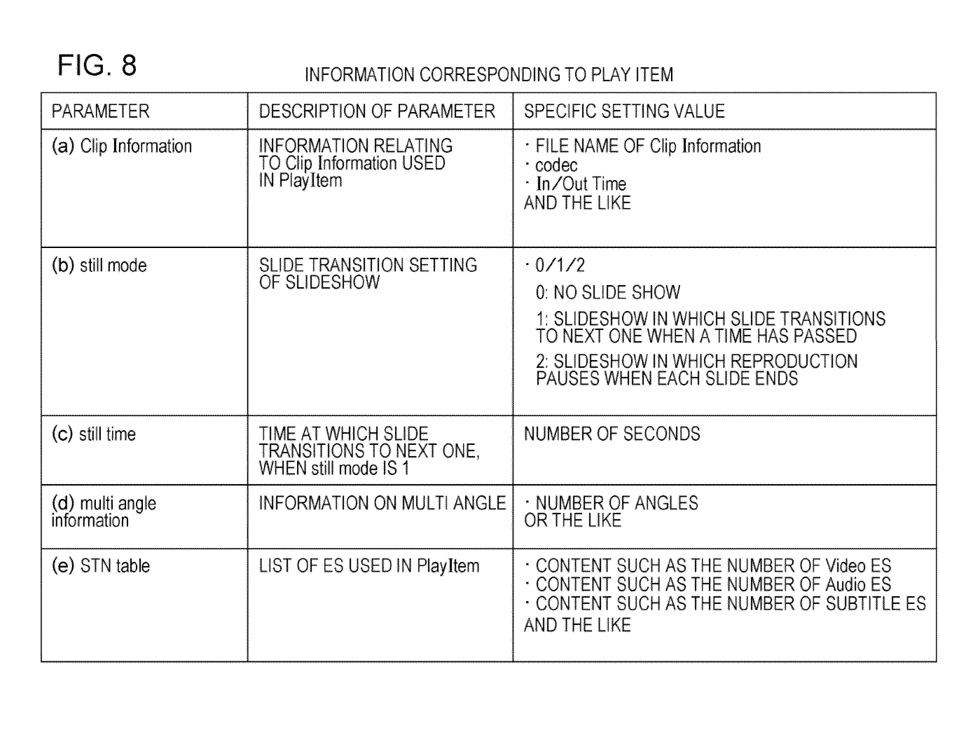

Next, specific example of reproduction control information of a playlist file which is applied to slideshow reproduction is described with reference to FIG. 8.

In the playlist file, the following information is recorded:

(1) information corresponding to a play item, and

(2) information corresponding to a sub path.

The information is used as control information that is applied to the slideshow reproduction.

First, with reference to FIG. 8,

(1) information corresponding to a play item is described.

The information corresponding to a play item is a data in which control information corresponding to each play item set as control information corresponding to each image (slide) displayed in the slideshow reproduction is recorded.

The following parameters are recorded in the information corresponding to a play item with respect to each play item as illustrated in FIG. 8:

(a) Clip information,

(b) Still mode,

(c) Still time,

(d) Multi angle information, and

(e) Stream number (STN) table.

In the (a) Clip information,

information relating to the clip information using the play item is described.

Examples include a file name and codec information of the clip information file, and the reproduction start point (In Time) and the reproduction end point (Out Time) of the image reproduced according to the play item.

In the (b) still mode, the slide transition setting of the slideshow is described.

Specifically, after the reproduction of the image displayed according to the play item reaches a reproduction end point, information on whether an image corresponding to the play item continues to be subjected to still display without change is recorded.

A play item in which still mode is set to 0 is not subject to still display. That is, the play item does not correspond to a slideshow.

A play item in which the still mode is set to 1 is continued to be subjected to the still display for a limited period of time.

A play item in which the still mode is set to 2 is continued to be subjected to the still display for an unlimited period of time. The reproduction of the image is continued in a still state. That is, the reproduction is in a paused state.

In addition, the display cancellation when the still display is continued for an unlimited period of time is performed by the explicit operation by the user.

In the (c) still time, when the still mode is set to 1, the duration time (second) of the still state until the transition to a next slide is designated.

In the (d) multi angle information, information relating to a multi angle in which videos in a plurality of angles are collectively managed in one play item is stored. For example, the multi angle information is information on the number of angles or the like.

In the (e) Stream number (STN) table, a list of Elementary Streams (ES) such as videos or sounds used in the play item is described. For example, the STN table is the number of Video ESs, Audio ESs, or subtitle ESs, and the content thereof.

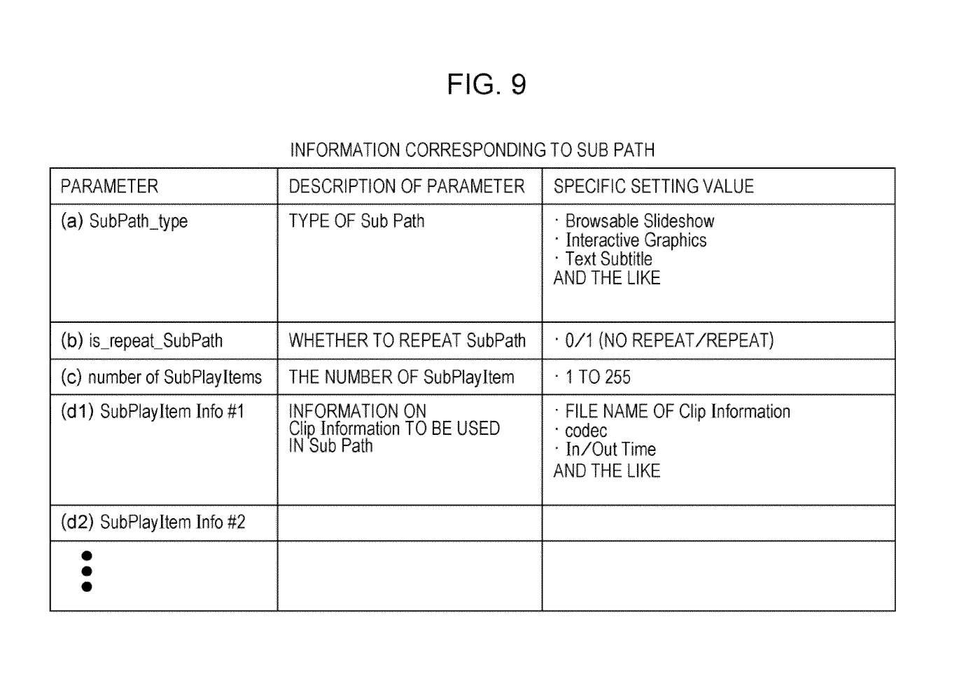

Next, (2) information corresponding to a sub path which is recorded in the playlist file is described with reference to FIG. 9.

The information corresponding to a sub path is data in which control information corresponding to each sub path set as control information corresponding to each sound reproduced in the slideshow reproduction is recorded.

In the information corresponding to a sub path, the following parameters are recorded for each sub path, as illustrated in FIG. 9:

(a) Type of Sub path (SubPath_type),

(b) Sub path repeat information (is_repeat_SubPath)

(c) The number of sub play items (number of SubPlayItems)

(d) Information on sub play item (SubPlayItem Info)

In the (a) type of a sub path (SubPath_type),

the types of sub paths are described. For example, information on the types of data reproduced by the sub path such as a browsable slideshow, an interactive audio, and a text subtitle is recorded.

In addition, in the case of a playlist which is applied to the slideshow reproduction, the parameter corresponds to the setting for a browsable slideshow.

In the (b) sub path repeat information (is_repeat_SubPath),

when a reproduction end point (Out Time) has been reached and the reproduction of the sound designated by the sub path is ended, the setting information on whether the repeat reproduction is automatically performed again or not is recorded.

In (c) the number of sub play items (number of SubPlayItems),

information on how many sub play items (SubPlayItem) are present which is information relating to the clip information used in the sub path is recorded.

In the (d) sub play item information (SubPlayItem Info),

information relating to the clip information used in the sub path is recorded.

For example, information such as a file name and a codec of the clip information, and a reproduction start point (In Time) and a reproduction end point (Out Time) of a sound file is recorded.

### [7. With Respect to Specific Example of Reproduction Form Corresponding to Setting of Still Mode]

As described with reference to FIG. 8, in the information corresponding to a play item, still mode information is recorded as information indicating whether to perform still display of an image displayed according to the play item.

As described above, the information corresponding to a play item is setting information as follows:

A play item in which the still mode is set to 0 is not subjected to still display. That is, the play item does not correspond to a slideshow.

The play item in which the still mode is set to 1 is continued to be subjected to still display for a limited period of time.

The play item in which the still mode is set to 2 is continued to be subjected to still display for an unlimited period. The reproduction of the image is continued in a still state. That is, the reproduction is in a paused state.

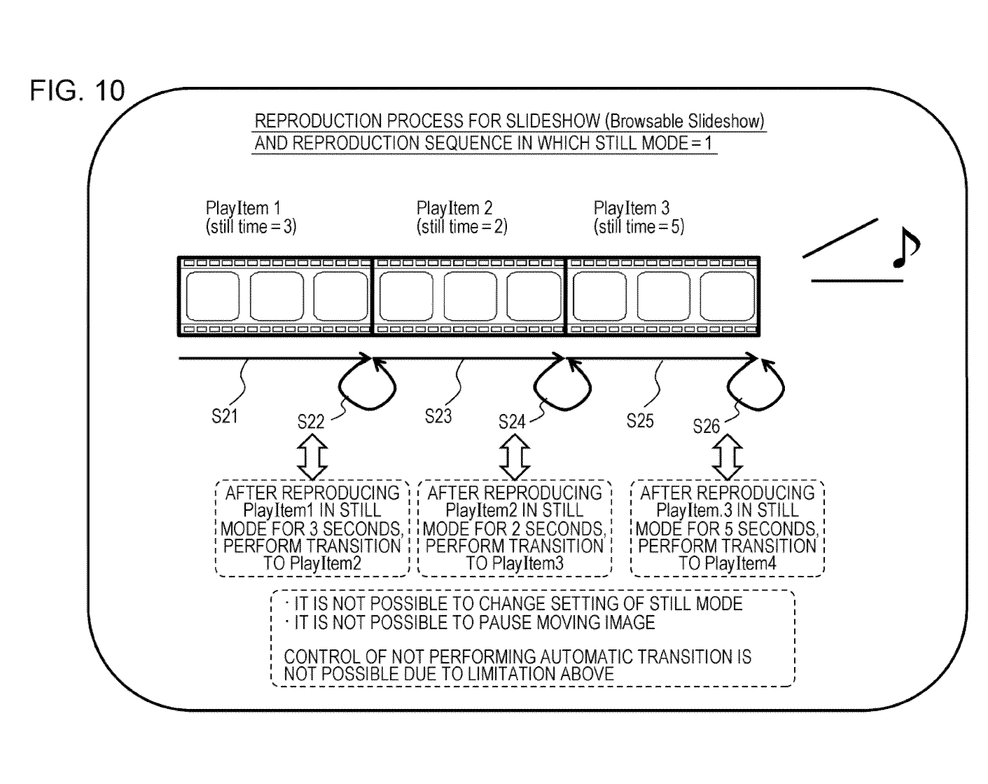

With reference to FIG. 10, processing according to the play item in which the still mode is set to 1 is described.

The setting of the still mode to 1 is a setting in which after reproduction end point (Out Time) has been reached, an image to be an object for reproduction control of the play item is continued to be subjected to image still display for a predetermined period of time (limited period of time), and a transition to a next image (slide) corresponding to a next play item is performed after a predetermined period of time.

In the example illustrated in FIG. 10, Play item 1 is a play item for controlling Image 1 (Slide 1) in which the still time is set to 3.

Play item 1 transitions to a next play item, that is, Play item 2 after 3 seconds from the reproduction end point (Out Time) of Image 1 (Slide 1), and the image switch (image switch from Slide 1 to Slide 2) is performed.

Play item 2 is a play item for controlling Image 2 (Slide 2) in which the still time is set to 2.

Play item 2 transitions to a next play item, that is, Play item 3 after 2 seconds from the reproduction end point (Out Time) of Image 2 (Slide 2), and the image switch (image switch from Slide 2 to Slide 3) is performed.

Specifically,

switch of play items (from Play item 1 to Play item 2) after still image display for three seconds according to the settings as follows:

Step S21: Reproduction of Slide 1 corresponding to Play item 1, and

Step S22: Setting of information corresponding to a play item of Play item 1, that is:

Still mode=1, and

Still time=3.

Switch of play items (from Play item 2 to Play item 3) after still image display for two seconds according to the settings as follows:

Step S23: Reproduction of Slide 2 corresponding to Play item 2, and

Step S24: Setting of information corresponding to a play item of Play item 2, that is:

Still mode=1, and

Still time=2.

Switch of play items (from Play item 3 to Play item 4) after still image display for five seconds according to the settings as follows:

Step S25: Reproduction of Slide 3 corresponding to Play item 3, and

Step S26: Setting of information corresponding to a play item of Play item 3, that is:

Still mode=1, and

Still time=5.

In the order described above, the switching and the reproduction of images (slides) are performed.

In this manner, the switching of each play item, that is, the image switching, is performed at a timing according to the still time set in the playlist file.

Since the setting information of the playlist file may not be freely rewritten, the still time may not be freely extended.

For example, even if the user continues to view an image in a still state without change, if the predetermined still time has passed, transition to a next image is performed.

Further, as described above with reference to FIG. 6 and other drawings, since the pause function or the changing speed reproduction of a video according to the user operation is not provided in the slideshow according to the BD standards, even if the user tries to pause, for example, a video in order to stop the automatic transition function of a control image according to, for example, a play item in which the still mode is set to 1 as illustrated in FIG. 10, the control similar to this may not be performed.

[8. With Respect to Configuration that Enables Stop and Transition of Image (Slide) to be Freely Controlled]

Next, processing according to the configuration of the present disclosure, that is, a configuration in which the pause or the transition of an image (slide) can be freely controlled is described.

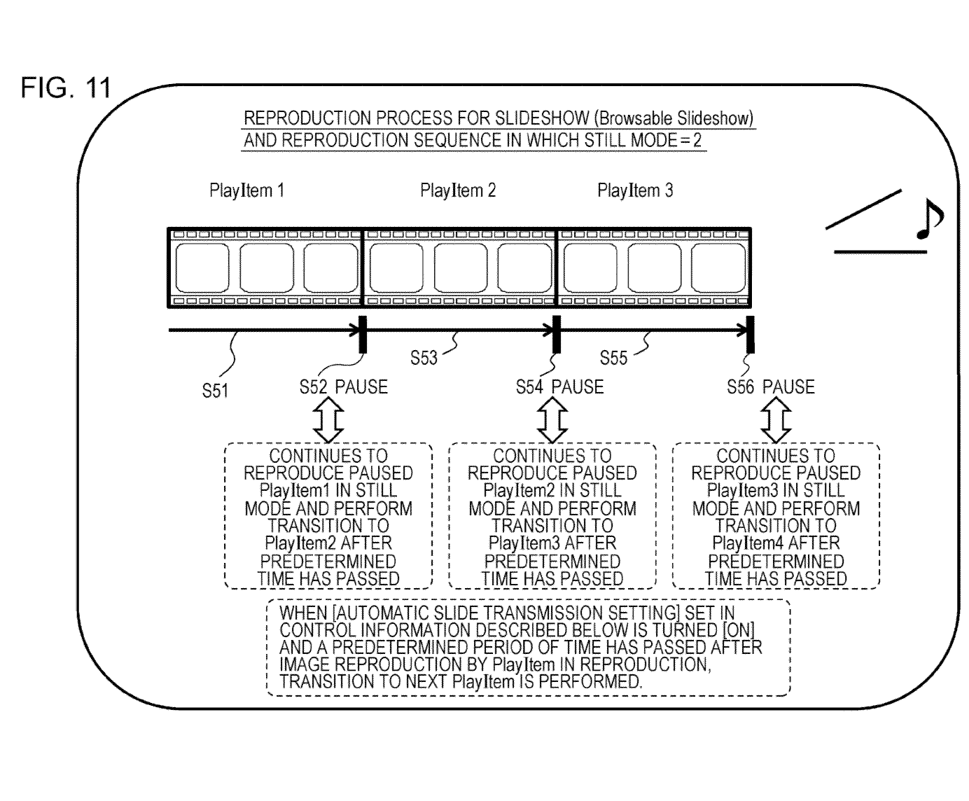

With reference to FIG. 11, an outline of the processing is described.

An example illustrated in FIG. 11 is processing according to the play item in which the still mode is set to 2.

The setting of the still mode to 2 is a pause setting in which after reproduction end point (Out Time) has been reached, an image to be an object for reproduction control of a play item is continued to be subjected to still display for an unlimited period of time without change.

The information in which the still mode is set to 2 is control information recorded in a playlist file, but in the configuration of the present disclosure, reproduction control information corresponding to the slideshow independently from the playlist file is further set.

As described above, slideshow reproduction processing is performed as processing in which a playlist designated by, for example, BD-J, is used. Various items of information described with reference to FIGS. 8 and 9 are recorded in the playlist file. Further, data for control which is applied to the slideshow reproduction is recorded, for example, by XML data in the BD-J file as a reproduction control program. At the time of the slideshow reproduction, processing is performed with reference to the control data (XML data) in the reproduction control program and the control data of the playlist file.

“Maximum display time” information indicating a maximum period of time for displaying an image (slide) in which each play item is used is described in the control data (XML data) in the reproduction control program.

At the time of the slideshow reproduction in the information processing apparatus, time for displaying an image (slide) according to each play item is measured. If the “maximum display time” recorded in the control data has passed, control for transition to a next play item is performed. According to the processing, a structure in which automatic slide paging can be turned on and off without interrupting the sound presentation can be provided.

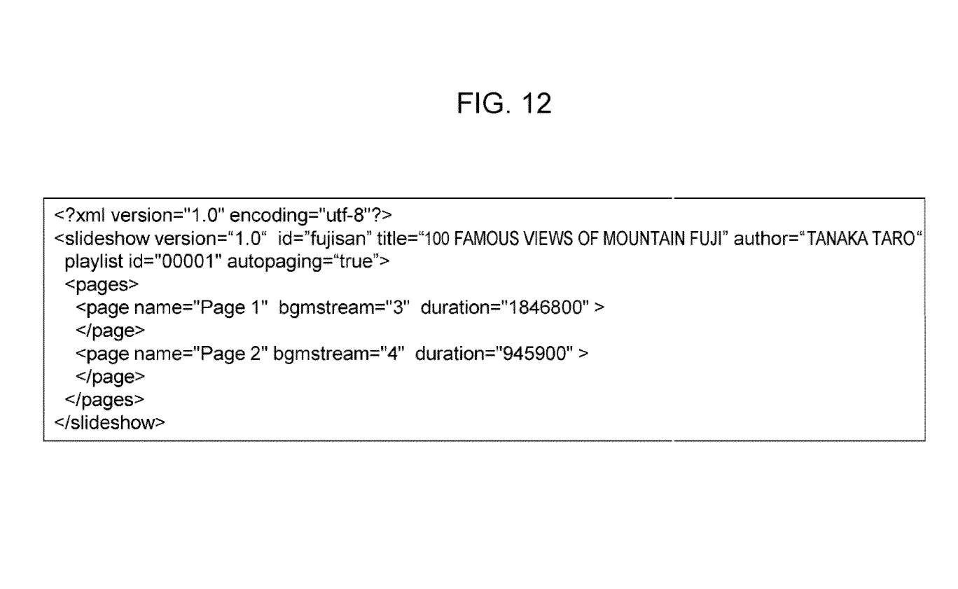

A specific example of control data (XML data) in the reproduction control program is described with reference to FIG. 12.

The control data illustrated in FIG. 12 is data as follows.

```
  <?xml version=“1.0” encoding=“utf-8”?>
  <slideshow version=“1.0” id=“Fujisan” title=“100 famous
views of Mt. Fuji” author=“TANAKA Taro”
  playlist id=“00001” autopaging=“true”>
    <pages>
      <page name=“Page 1” bgmstream=“3”
duration=“1846800”>
      </page>
      <page name=“Page 2” bgmstream=“4” duration=“945900”>
      </page>
    </pages>
  </slideshow>
```

The aforementioned control data is described.

[slideshow version=“1.0]

This presents a version of the format of slideshow control information.

[“id=“Fujisan” title=“100 famous views of Mt. Fuji” author=“TANAKA Taro”]

These are an identifier, a title, and author information of the slideshow content.

[playlist id=“00001”]

The above is playlist identifier information.

[autopaging=“true”]

This is setting information on automatic slide paging function flag.

The setting in which the automatic slide paging function flag is “true” indicates that the setting is ON, that is, valid, and

the setting in which the automatic slide paging function flag is “false” indicates that the setting is OFF, that is, invalid.

In addition, if the automatic slide paging function is set to “true”, the user can freely select whether to perform processing in which the function is used or not. The selection processing by the user will be described below.

After <pages>, the following information is recorded as information on an image (slide) for presenting each play item.

[page name=“Page 1”]

This is information indicating a page name. This corresponds to each image (slide).

[bgmstream=“3”]

This is an identifier of a sound stream to be reproduced at the time of slide display.

[duration=“1846800”]

This is “maximum display time” of the image (slide).

In addition, “1846800” indicating the “maximum display time” is time information in the unit of 45 kHz. The unit of 45,000 corresponds to 1 second.

Returning to FIG. 11, control sequence for displaying the image (slide) to which the control data illustrated in FIG. 12 is applied is described.

The image reproduction control illustrated in FIG. 11 is processing to which recording information of the playlist file described with reference to FIGS. 8 and 9 as the reproduction control information and control data (XML data) in the reproduction control program described with reference to FIG. 12.

Specifically, the following information is recorded as the information corresponding to the play item of the playlist file.

Still mode of play item=2,

That is, this is a setting for pausing display without change in a still image display state after the reproduction end point of an image corresponding to each play item.

Further, in the control data (XML data) in the reproduction control program, as control information for each play item,

the automatic slide paging function flag is set to “true”, that is, the automatic slide changing setting is ON, that is, valid.

Further,

the “maximum display time” corresponding to each play item, that is,

[duration=“xxxxxx”]

the aforementioned “maximum display time” information is recorded.

A reproduction sequence to which the control information is applied is described according to each of Steps S51 to 56 of FIG. 11. According to the setting below:

Step S51: Reproduction of Slide 1 corresponding to Play item 1, and

Step S52: Information corresponding to a play item of Play item 1, that is,

Still mode=2,

still image display according to the pause processing is started, the still image display of Slide 1 is continued until the display time from the reproduction start of Slide 1 corresponding to Play item 1 reaches the “maximum display time”, and in the condition in which Display time=“Maximum display time” is satisfied,

switching of the play items (Play item 1 to Play item 2) is performed.

According to the setting below:

Step S53: Reproduction of Slide 2 corresponding to Play item 2, and

Step S54: Setting of information corresponding to a play item of Play item 2, that is,

Still mode=2,

still image display according to the pause processing is started, the still image display of Slide 2 is continued until the display time from the reproduction start of Slide 2 corresponding to Play item 2 reaches the “maximum display time”, and in the condition in which Display time=“Maximum display time” is satisfied,

switching of the play items (Play item 2 to Play item 3) is performed.

According to the setting below:

Step S55: Reproduction of Slide 3 corresponding to Play item 3, and

Step S56: Setting of information corresponding to a play item of Play item 3, that is,

Still mode=2,

still image display according to the pause processing is started, the still image display of Slide 3 is continued until the display time from the reproduction start of Slide 3 corresponding to Play item 3 reaches the “maximum display time”, and in the condition in which Display time=“Maximum display time” is satisfied,

switch of the play items (Play item 3 to Play item 4) is performed.

The reproduction control of the image (slide) is performed in this sequence.

### [9. With Respect to Processing Sequence for Executing Information Processing Apparatus]

Next, the processing sequence performed by the information processing apparatus of the present disclosure is described with reference to a flow chart.

In addition, as described above, the content reproduction control of the present disclosure is performed as processing to which the reproduction control information recorded in the playlist file and the reproduction control information (for example, the XML data illustrated in FIG. 12) recorded in the reproduction control program such as BD-J are applied. The processing is performed as execution processing of, for example, the reproduction control program (BD-J) in the data processing unit 201 of the information processing apparatus 101 illustrated in FIG. 2.

In addition, when the reproduction sequence illustrated in FIG. 11 is performed, it is presented that

the setting of the automatic slide paging function in the setting information of the reproduction control information (for example, the XML data illustrated in FIG. 12) recorded in the reproduction control program such as BD-J, that is,

[autopaging]

the setting of the automatic slide paging function flag is “true”.

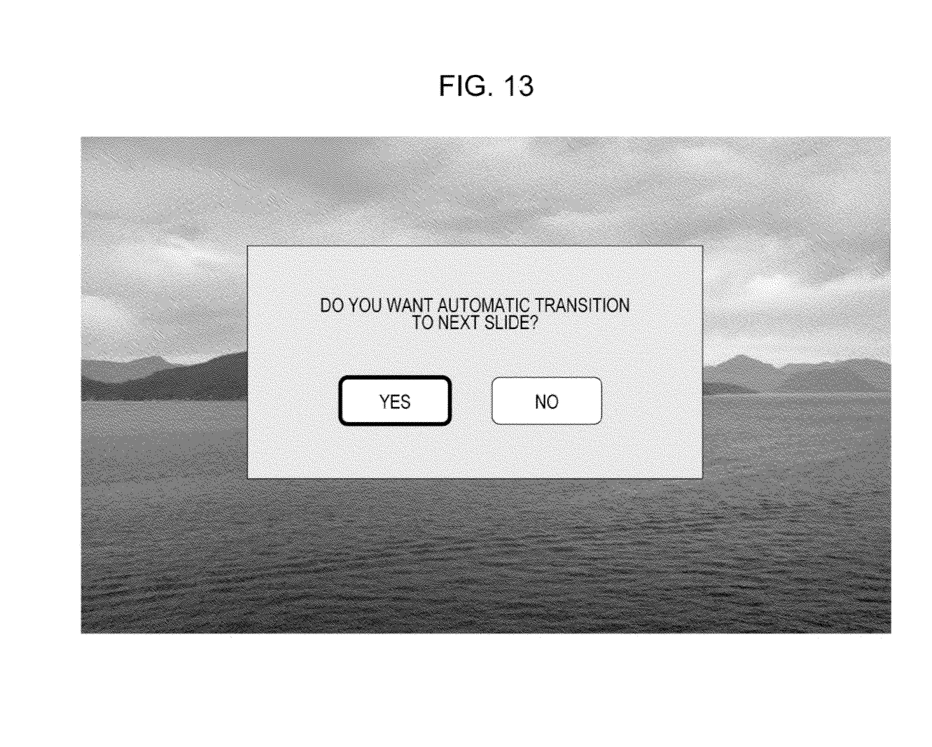

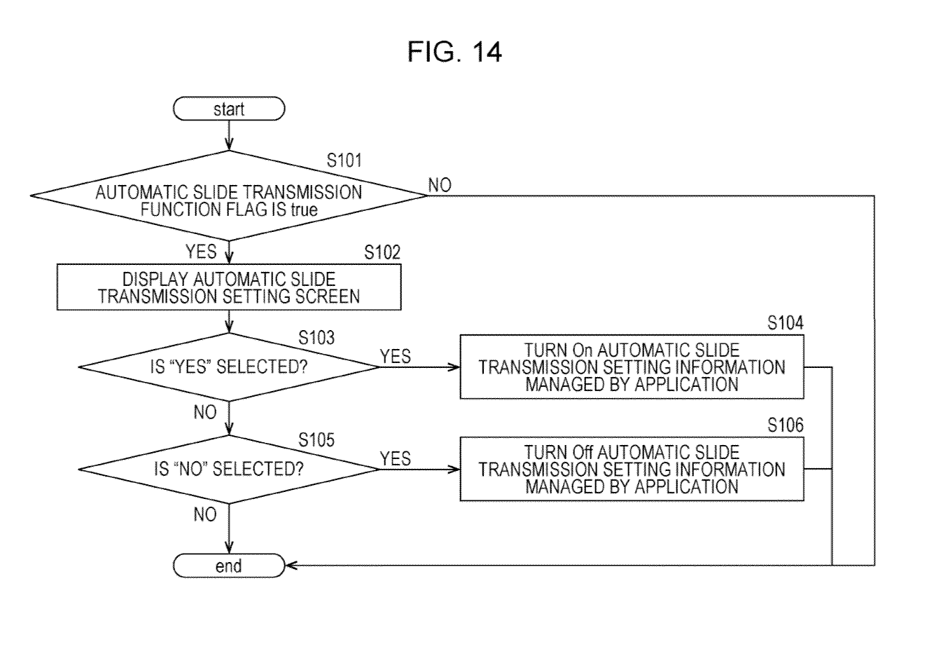

When the automatic slide paging function is set to “true”, the user can freely select whether to perform the processing using the function. The selection processing by the user is described with reference to FIGS. 13 and 14.

FIG. 13 is an exemplary screen (GUI) for the user to set whether to perform the processing using the automatic slide paging. The user can set whether to perform the automatic slide paging by performing user input to such screen (GUI).

The processing sequence when the automatic slide paging setting by using the GUI illustrated in FIG. 13 is performed is described with reference to a flow chart illustrated in FIG. 14.

First, if a title corresponding to the slideshow reproduction is designated by the user, the processing is started by activating the reproduction control program (BD-J) corresponding to the title.

First, in Step S101, with reference to the control information (for example, The XML data illustrated in FIG. 12) in which the reproduction control program corresponding to the slideshow, the data processing unit of the information processing apparatus determines whether the setting of the automatic slide paging function flag, that is, the setting of

[autopaging]

is “true” which indicates valid.

If the setting is valid, “true”, the processing proceeds to Step S102. If the setting is invalid, “false”, the automatic slide paging setting may not be performed, and the process ends.

If the setting of the automatic slide paging function flag is valid, that is, “autopaging=true”, the processing proceeds to Step S102 and the setting screen (GUI) illustrated in FIG. 13 is displayed.

It may be considered that the timing at which the setting screen is displayed is time, for example, at which the user selects an item for setting the automatic slide paging on the setting screen of the program.

If it is detected that “Yes” is selected as user input in Step S103, the processing proceeds to Step S104, a parameter of indicating the setting information “On” in which the automatic slide paging function is used is set in a region for storing parameter setting information on a memory used as a work area of the reproduction control program in execution, and the processing ends.

If it is not detected that “Yes” is selected as user input in Step S103, the processing proceeds to Step S105, and if it is detected that “No” is selected as user input in Step S103, the processing proceeds to Step S106.

A parameter of indicating the setting information “Off” in which the automatic slide paging function is not used is set in a region for storing parameter setting information on a memory used as a work area of the reproduction control program in execution in Step S106, and the processing ends.

If it is not detected that “No” is selected as a user input in Step S106, after a certain period of time has passed, the processing ends.

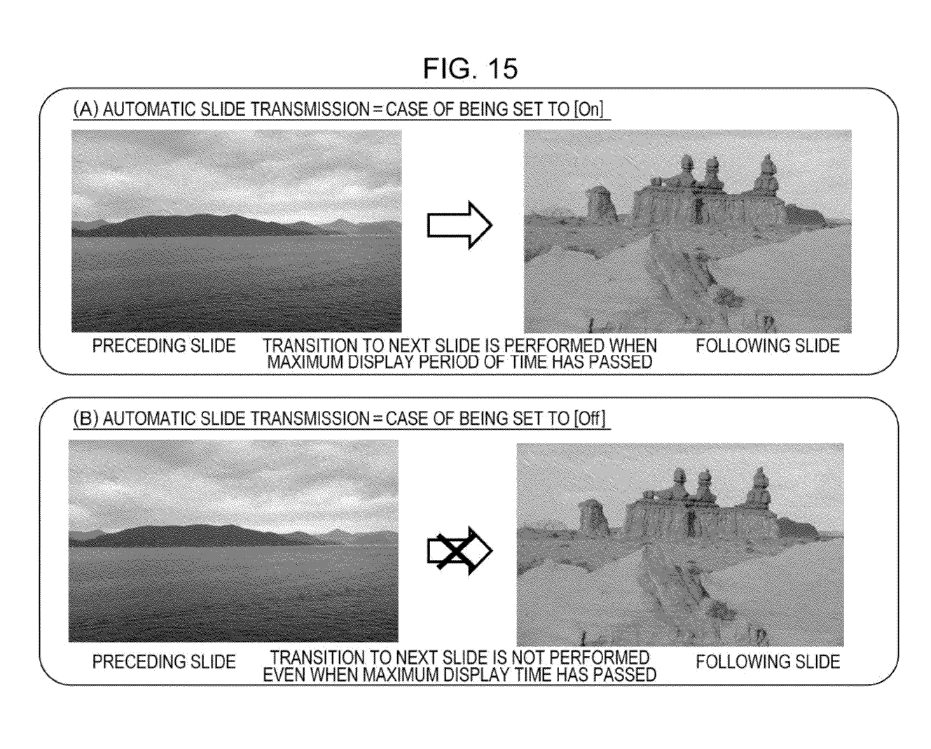

FIG. 15 is a diagram illustrating the difference between an operation when the automatic slide paging is set to On and an operation when the automatic slide paging is set to Off. The following Processing examples are illustrated in FIG. 15:

(A) Setting in which Automatic slide paging=[On], and

(B) Setting in which Automatic slide paging=[Off].

In the (A) setting in which automatic slide paging=[On], the image transition processing is performed by applying not only the setting in which

Still mode of play item=2,

that is, setting information for pausing display without change in a still image display state after the reproduction end point of an image corresponding to each play item, but also

the “maximum display time” corresponding to each play item recorded in the control data (XML data) in the reproduction control program, that is,

[duration=“xxxxxx”].

In this case, the transition of the image (slide) is performed as follows.

The preceding slide is started to be displayed in a still image display by the pause processing according to the setting of the play item for the information corresponding to the play item, that is, the setting in which

Still mode=2.

The still image display of the slide continues to be displayed until the display time from the reproduction start of the slide corresponding to the play item reaches the “maximum display time”. In the condition in which Display time=“Maximum display time”,

the transition processing to a following image is performed by the switch of the play item.

Meanwhile,

in the setting of the (B) automatic slide paging=[Off], control is performed according to only the setting in which

Still mode of Play item=2,

that is, setting information for pausing display without change in a still image display state after the reproduction end point of an image corresponding to each play item.

In this case, the transition of the image (slide) is performed as follows.

The preceding slide is started to be displayed in the still image display by the pause processing according to the setting of the play item for the information corresponding to the play item, that is,

Still mode=2.

Thereafter, if the user does not explicitly perform slide transition instruction, a transition to a following image is not performed.

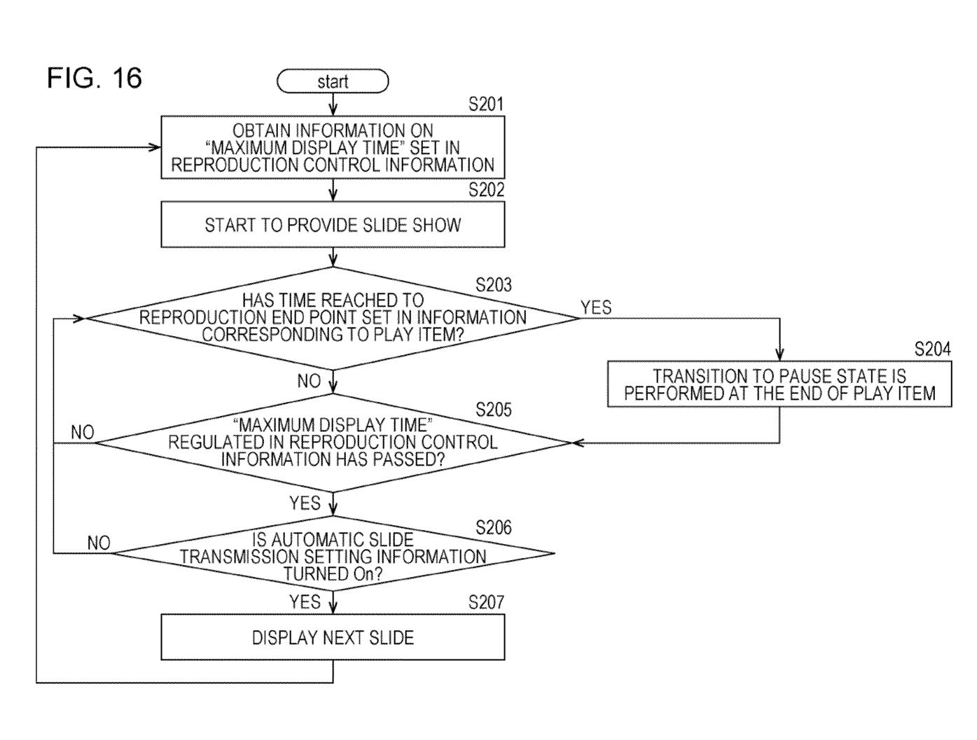

Next, the reproduction sequence of the slideshow is described with reference to the flow chart illustrated in FIG. 16.

In addition, the slideshow reproduction illustrated in FIG. 16 is processing based on the setting the same as the aforementioned setting with reference to FIG. 11. That is,

the setting of the play item for the still mode of the information corresponding to the play item is

Still mode=2,

that is, the setting for pausing display without change in a still image display state after the reproduction end point of an image corresponding to each play item.

Further, the following “maximum display time” information is recorded in the control data (XML data) in the reproduction control program, as control information for each play item:

Setting of automatic slide paging function flag=“true”, and

“Maximum display time” corresponding to each play item, that is,

[Duration=“xxxxxx”].

The reproduction sequence of the slideshow satisfies the aforementioned conditions.

Processing of steps illustrated in the flow chart in FIG. 16 is described.

First, if a title corresponding to the slideshow reproduction is designated by the user, the processing is started by activating the reproduction control program (BD-J) corresponding to the title.

In addition, the processing in the flow chart illustrated in FIG. 16 is an image display sequence corresponding to one play item. The processing according to the flow chart illustrated in FIG. 16 is performed in a play item basis.

First, in Step S201, with reference to control information (for example, the XML data illustrated in FIG. 12) of the reproduction control program corresponding to the play item that is the processing object, the data processing unit of the information processing apparatus obtains the “maximum display time” corresponding to the play item, that is, the “maximum display time” of

[Duration=“xxxxxx”].

Next, the display of the image (slide) corresponding to the play item that is the processing object in Step S202 is started.

Next, it is determined whether the reproduction end point (Out Time) regulated in the information corresponding to the play item in Step S203 has been reached.

The information corresponding to a play item is the control information recorded in the playlist described above with reference to FIG. 8.

It is determined whether the reproduction end point (Out Time) recorded as the information corresponding to a play item of the playlist has been reached.

If it is determined that the reproduction end point (Out Time) recorded as the information corresponding to a play item of the playlist has been reached (Yes in Step S203), the processing proceeds to Step S204.

In Step S204, the current image display in a paused state is continued.

The processing is a still image display processing by the pause processing according to the setting of the information corresponding to a play item, that is, the setting in which

Still mode=2.

After this processing, the processing proceeds to Step S205.

If the determination in Step S203 is No, that is, if it is not determined that the reproduction end point (Out Time) recorded as the information corresponding to a play item of the playlist has been reached, or if the pause processing of Step S204 is not performed, the processing proceeds to Step S205 in both cases.

In Step S205, it is determined whether the display time of the image corresponding to the play item that is the processing object has passed the “maximum display time” obtained in Step S201.

“The maximum display time” obtained in Step S201 is the “maximum display time” corresponding to the play item of the control information (for example, the XML data in FIG. 12) of the reproduction control program, that is, the “maximum display time” of [duration=“xxxxxx”].

In Step S205, if it is determined that the display time of the image corresponding to the play item which is the processing object has not passed the “maximum display time” obtained in Step S201, the processing proceeds to Step S203.

Meanwhile, in Step S205, if it is determined that the display time of the image corresponding to the play item that is the processing object has passed “the maximum display time” obtained in Step S201, the processing proceeds to Step S206.

In Step S206, it is determined whether the automatic slide paging setting information which is the user setting information described above with reference to FIGS. 13 and 14 is set to “On”.

If the setting is not “On”, the processing returns to Step S203, and the processing is continued.

The processing in this case is processing performed according to the control only by the setting in which

Still mode of Play item=2,

that is, the setting information for pausing display without change in a still image display state after the reproduction end point of an image corresponding to each play item.

In this case, the transition of the image (slide) is performed as follows.

The preceding slide is started to be displayed in the still image display by the pause processing according to the setting of the play item for the information corresponding to the play item, that is,

Still mode=2.

Thereafter, if the user does not explicitly perform slide transition instruction, a transition to a following image is not performed.

The processing is performed corresponding to the slide transition of FIG. 15(B).

Meanwhile, if it is determined that the automatic slide paging setting information that is the user setting information is set to “On” in Step S206, the processing proceeds to Step S207.

In Step S207, display switch to a next image (slide) is performed. That is, the switch processing of the play item is performed.

The processing of Step S201 and the subsequent steps is performed on the next play item.

In addition, if the determination in Step S206 is Yes, the processing of performing the slide transition in Step S207 corresponds to the processing of FIG. 15(A).

That is,

the image transition processing is performed by applying not only the setting in which

Still mode of Play item=2,

that is, the setting information for pausing display without change in a still image display state after the reproduction end point of an image corresponding to each play item, but also

the “maximum display time” corresponding to each play item recorded in the control data (XML data) in the reproduction control program, that is,

[duration=“xxxxxx”].

Further, the steps in the flow charts of FIGS. 16 and 14 can be operated in parallel, and in this case, the automatic slide paging setting information may be changed in the middle of the processing of FIG. 16. Accordingly, the automatic slide paging is performed first and the automatic slide paging is not performed in the middle, or the processing can be controlled in the reversed manner.

In this case, the transition of the image (slide) is performed as follows.

The preceding slide is started to be displayed in the still image display by the pause processing according to the setting of the play item for the information corresponding to the play item, that is,

Still mode=2.

The still image display of the slide is continued to be displayed until the display time from the reproduction start of the slide corresponding to the play item reaches the “maximum display time”. In the condition in which Display time=“Maximum display time”,

the transition processing to a following image is performed by the switch of the play item.

In this manner, in the information processing apparatus of the present disclosure, the image display control with a higher degree of freedom that may not be realized by only the control information of the playlist can be realized by applying the control information that regulates the “maximum display time” of each image, in addition to the control information of each image that is regulated in the playlist file.

[10. With Respect to Renewal Processing in which Control Information from Server is Used]

As described above, the information processing apparatus in the reproduction processing of the slideshow executes processing that uses the following data which is the reproduction control information recorded in the playlist file:

Information corresponding to a play item (FIG. 8),

Information corresponding to a sub path (FIG. 9), and

Control data in reproduction control program (FIG. 12).

The reproduction control data is recorded on an information recording medium on which content is recorded, for example, on a Blu-ray Disc (BD), together with the image and the sound data which are applied to the slideshow reproduction.

However, the reproduction control data can be used, for example, by being received from a server that can perform a communication through a network.

For example, it is possible to perform the reproduction processing by renewing the control data that is recorded on the information recording medium into new control data received from the server and using the renewed control data.

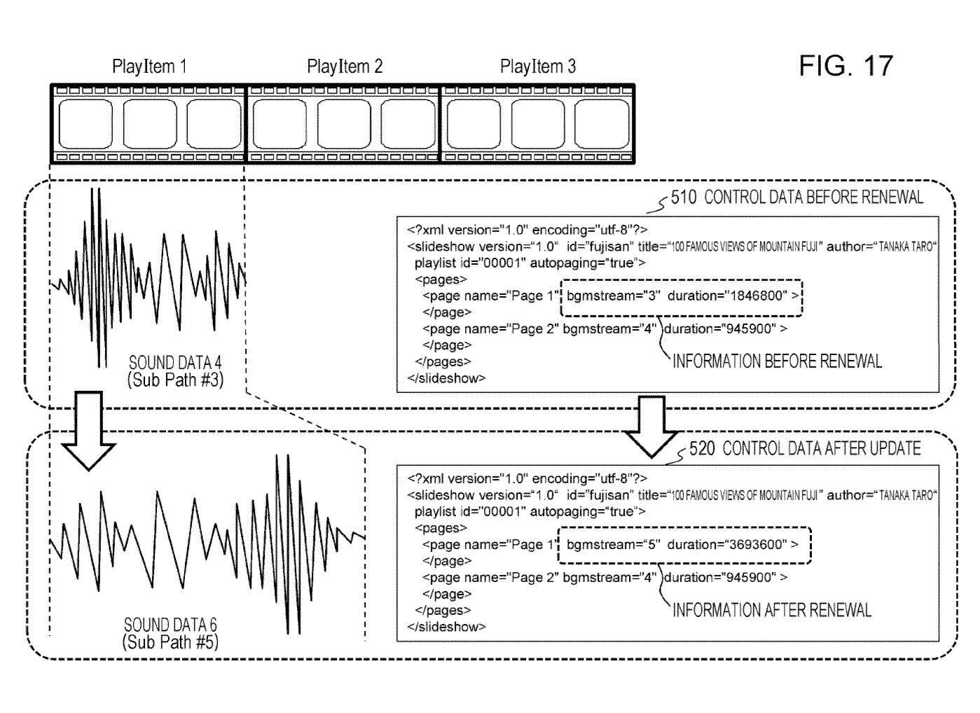

An example of processing for renewing the control data is described with reference to FIG. 17.

FIG. 17 is a diagram illustrating an example of renewal processing of the control data (XML data) in the reproduction control program described above with reference to FIG. 12.

A control data before renewal 510 is control data which is recorded on the information recording medium, together with the image and the sound data which are applied to the slideshow.

The information processing apparatus is connected to a server through a network, and receives renewed new control data from the server. The new control data is a control data after renewal 520 illustrated in FIG. 17.

The control data after renewal 520 may be stored in a recording medium different from the information recording medium in which the image and the sound data applied to the slideshow is recorded, such as a hard disk. Otherwise, if the information recording medium in which the image and the sound data applied to the slideshow is recorded is a medium that can write data, the control data after renewal 520 may be stored in the information recording medium.

The example illustrated in FIG. 17 is an example of renewal processing for renewing the sound data that is reproduced according to the play item.

With respect to the data reproduced according to Play item 1, the control data before renewal 510 is a setting in which

the sound data is set to Sound data 4 reproduced according to Sub path #3, and

the maximum display time (duration) of the image is set to [1846800].

Meanwhile, with respect to the data reproduced according to Play item 1, the control data after renewal 520 is a setting in which

the sound data is set to be Sound data 6 reproduced according to Sub path #5, and

the maximum display time (duration) of the image is set to [3693600].

That is, the maximum display time of the image and the sound data which is reproduced when the image according to Play item 1 is reproduced is changed according to the renewal of the control data.

The information processing apparatus that performs the slideshow reproduction can perform the slideshow reproduction having the control form different from the form before the renewal by performing the slideshow reproduction using the control data after renewal 520.

### [10. With Respect to Collective Configuration of the Present Disclosure]

Hereinabove, embodiments of the present disclosure are described in detail with reference to specific embodiments. However, it is obvious that the embodiments can be modified or substituted by a person skilled in the art without departing from the gist of the present disclosure. Namely, the embodiments have been presented as examples, and should not be construed to limit the present disclosure. The gist of the present disclosure should be determined with reference to the scope of the accompanying claims of the present disclosure.

In addition, the technology disclosed in the present specification can be configured as follows.

(1) An information processing apparatus including:

a data processing unit that performs reproduction control of a slideshow in which images are sequentially switched and displayed,

in which the data processing unit performs reproduction control by applying

first control data in which information on a reproduction start point and a reproduction end point of each image is recorded, and

second control data in which information on maximum display time of each image is recorded, and

performs image transition processing according to whether the maximum display time for reproducing the second control data has passed, regardless of whether the reproduction end point of the first control data has passed.

(2) The information processing apparatus according to (1), in which when automatic slide paging setting as user setting information is ON (valid), the data processing unit performs image transition processing as the maximum display time for reproducing the second control data has passed.

(3) The information processing apparatus according to (1) or (2), in which if a setting of still mode information for each image included in the first control data is a setting of pause mode for continuously displaying the image after the reproduction reproduction end point has been reached, the data processing unit performs image transition processing as the maximum display time for reproducing the second control data has passed.

(4) The information processing apparatus according to any one of (1) to (3), in which if image display time reaches the reproduction end point of the first control data, the data processing unit continues to display the image in a state in which the displayed image is paused, and performs image transition processing as the maximum display time for reproducing the second control data has passed after the pause.

(5) The information processing apparatus according to any one of (1) to (4), in which if the maximum display time for reproducing the second control data has passed before image display time reaches the reproduction end point of the first control data, the data processing unit performs the image transition processing.

(6) The information processing apparatus according to any one of (1) to (5), in which the first control data is control data regulated in a playlist file which is a reproduction control information file corresponding to the slideshow.

(7) The information processing apparatus according to any one of (1) to (6), in which the second control data is control data described as XML data.

(8) The information processing apparatus according to any one of (1) to (7), in which the data processing unit receives the second control data from a server connected through a network, and performs reproduction control in which reception control data is applied.

Additionally, a method of processing performed in the apparatus and the system described above and a program causing the apparatus and the system to perform the processing are included in the configuration of the present disclosure.

Further, a series of processing described in the specification can be performed by hardware, software, or a combination of the hardware and the software. If the processing is performed by the software, it is possible to execute a program in which a processing sequence is recorded by installing the program on a memory in a computer integrated in dedicated hardware or to execute a program by installing the program on a general computer that can execute various types of processing. For example, the program can be recorded in advance in a recording medium. In addition to the installing of the program on a computer from the recording medium, it is possible to receive the program through a network such as a Local Area Network (LAN) or the Internet and install the program on a recording medium such as an embedded hard disk.

In addition, various types of processing described in the specification may be performed in a sequence as described above, or may be performed in parallel or individually, according to the processing performance of the apparatus that performs the processing or as necessary. Further, the system in the present specification is a configuration obtained by logically assembling a plurality of apparatuses, and each configuration apparatus is not necessarily provided in the same housing.

### INDUSTRIAL APPLICABILITY

As described above, an apparatus and a method that perform reproduction control with a high degree of freedom on slideshow reproduction can be realized by the configuration according to an embodiment of the present disclosure.

Specifically, reproduction control to which first control data in which information on a reproduction start point and a reproduction end point of an image is recorded and second control data in which information on maximum display time of each image is recorded are applied is performed. When automatic slide paging setting as user setting information is ON (valid), image transition processing is performed according to whether the maximum display time for reproducing the second control data has passed, regardless of whether the reproduction end point of the first control data has passed. For example, if image display time reaches the reproduction end point of the first control data, the image is continuously displayed in a state in which the displayed image is paused, and image transition processing is performed as the maximum display time for reproducing the second control data has passed after the pause.

Reproduction control with a high degree of freedom in slideshow reproduction can be realized by the processing described above.

### REFERENCE SIGNS LIST

101 INFORMATION PROCESSING APPARATUS
102 INFORMATION RECORDING MEDIUM
103 DISPLAY DEVICE
104 REMOTE CONTROLLER
105 NETWORK
106 SERVER
107 CONTENT DATABASE
201 DATA PROCESSING UNIT (CPU)
202 SOUND DATA PROCESSING UNIT
203 IMAGE DATA PROCESSING UNIT
204 GRAPHIC ENGINE
205 IMAGE OUTPUT UNIT
206 SOUND OUTPUT UNIT
207 RAM
208 EXTERNAL IF
209 STORAGE UNIT
210 ROM
211 NETWORK CONTROLLER
212 SWITCHER
213 DRIVE
214 HARD DISK
221 INPUT/OUTPUT BUS
222 SYSTEM BUS
223 MEMORY BUS
301 INDEX FILE
302 REPRODUCTION CONTROL PROGRAM
303 PLAYLIST FILE
304 CLIP
401 PLAYLIST FILE
402 CLIP INFORMATION FILE
403 CLIP AV STREAM FILE
510 CONTROL DATA BEFORE RENEWAL
520 CONTROL DATA AFTER RENEWAL

1. An information processing apparatus comprising:
a data processing unit that performs reproduction control of a slideshow in which images are sequentially switched and displayed,
wherein the data processing unit performs reproduction control by applying
first control data in which information on a reproduction start point and a reproduction end point of each image is recorded, and
second control data in which information on maximum display time of each image is recorded, and
performs image transition processing according to whether the maximum display time for reproducing the second control data has passed, regardless of whether the reproduction end point of the first control data has passed.

2. The information processing apparatus according to claim 1,
wherein when automatic slide paging setting as user setting information is ON (valid), the data processing unit performs image transition processing as the maximum display time for reproducing the second control data has passed.

3. The information processing apparatus according to claim 1,
wherein if a setting of still mode information for each image included in the first control data is a setting of pause mode for continuously displaying the image after the reproduction reproduction end point has been reached, the data processing unit performs image transition processing as the maximum display time for reproducing the second control data has passed.

4. The information processing apparatus according to claim 1,
wherein if image display time reaches the reproduction end point of the first control data, the data processing unit continues to display the image in a state in which the displayed image is paused, and performs image transition processing as the maximum display time for reproducing the second control data has passed after the pause.

5. The information processing apparatus according to claim 1,
wherein if the maximum display time for reproducing the second control data has passed before image display time reaches the reproduction end point of the first control data, the data processing unit performs the image transition processing.

6. The information processing apparatus according to claim 1,
wherein the first control data is control data regulated in a playlist file which is a reproduction control information file corresponding to the slideshow.

7. The information processing apparatus according to claim 1,
wherein the second control data is control data described as XML data.

8. The information processing apparatus according to claim 1,
wherein the data processing unit receives the second control data from a server connected through a network, and performs reproduction control to which reception control data is applied.

9. An information processing method comprising:
performing reproduction control of a slideshow in which images are sequentially switched and displayed, of an information processing apparatus,
wherein a data processing unit performs reproduction control by applying
first control data in which information on a reproduction start point and a reproduction end point of each image is recorded, and
second control data in which information on maximum display time of each image is recorded, and
performs image transition processing according to whether the maximum display time for reproducing the second control data has passed, regardless of whether the reproduction end point of the first control data has passed, in the reproduction control processing.

10. A program causing an information processing apparatus to perform reproduction control of a slideshow in which images are sequentially switched and displayed,
wherein a data processing unit performs reproduction control by applying
first control data in which information on a reproduction start point and a reproduction end point of each image is recorded, and
second control data in which information on maximum display time of each image is recorded, and
performs image transition processing according to whether the maximum display time for reproducing the second control data has passed, regardless of whether the reproduction end point of the first control data has passed, in the reproduction control processing.
